(19) United States
(12) Patent Application Publication
(10) Pub. No.: US 2020/0161940 A1
(43) Pub. Date: May 21, 2020

(54) ELECTRICAL ENERGY PRODUCTION SYSTEM AND METHOD FOR OPERATING AN ELECTRICAL ENERGY PRODUCTION SYSTEM

(71) Applicant: SIEMENS MOBILITY GMBH, MUENCHEN (DE)

(72) Inventors: BERNHARD HOESCHELER, ERLANGEN (DE); ROBERT SCHMID, HEROLDSBACH (DE); JUERGEN SCHURR, ERLANGEN (DE)

(21) Appl. No.: 16/632,573

(22) PCT Filed: May 7, 2018
(86) PCT No.: PCT/EP2018/061708

§ 371 Date: Jan. 21, 2020

(30) Foreign Application Priority Data
Jul. 21, 2017 (DE) 10 2017 212 572.1

(51) Int. Cl. H02K 11/04; H02K 7/18

(52) U.S. Cl. CPC H02K 11/048; H02K 7/1815

(57) ABSTRACT

An electrical energy production system includes a diesel engine that is functionally coupled to a three-phase current generator device, the generator device is functionally coupled to an electrical intermediate circuit, the electrical intermediate circuit is functionally coupled to an electric consumer device and a passive rectifier and a pulse rectifier are connected in parallel in the intermediate circuit. An electrical intermediate circuit voltage of the electrical intermediate circuit is provided, in a defined manner, from the passive rectifier and the pulse rectifier. A set point or nominal value of the electrical intermediate circuit voltage is supplied to the pulse rectifier and the pulse rectifier provides a defined portion of the electrical intermediate circuit voltage. A method for operating an electrical energy production system and a computer program product are also provided.

The invention relates to an electrical energy production system. The invention also relates to a method for operating an electrical energy production system. The invention also relates to a computer program product.

In particular for traction purposes in the field of rail vehicles with an electric drive it is necessary to be able to set an intermediate electric circuit voltage freely within wide limits in accordance with various parameters (e.g. converted power, velocity, auxiliary operating power, etc.).

If the pure traction function of a diesel-electric vehicle is considered, the function is conventionally performed by virtue of the fact that a diesel engine is coupled directly to a direct current generator or to a three-phase current generator with a diode rectifier connected downstream. The rotational speed of the diesel engine follows, for example, what is referred to as a “propeller curve” here.

The generators usually have separate electrical excitation. Therefore, without external influences there is a resulting intermediate electric circuit voltage approximately in proportion to the diesel engine rotational speed, wherein this characteristic fits well with the requirements of the traction motors. The exciter devices perform fine adjustment and load balancing here.

An object of the present invention is to provide an improved electrical energy production system. The object is achieved according to a first aspect with an electrical energy production system comprising:
a diesel engine which is functionally coupled to a three-phase current generator device;
wherein the generator device is functionally coupled to an intermediate electric circuit,
wherein the intermediate electric circuit is functionally coupled to an electric consumer device;
wherein a passive rectifier and a pulse rectifier are connected in parallel in the intermediate circuit;
wherein an intermediate electric circuit voltage of the intermediate electric circuit can be provided in a defined fashion by the passive rectifier and the pulse rectifier;
wherein a set point value of the intermediate electric circuit voltage can be fed to the pulse rectifier;
wherein a defined portion of the intermediate electric circuit voltage can be provided in a defined working range by means of the pulse rectifier.

In this way, dependence of a provision of the intermediate electrical voltage on the rotational speed of the diesel engine is advantageously eliminated. As a result, efficient operation of the diesel engine can advantageously be implemented, wherein a defined portion of a step-up converter function of the pulse rectifier is used to electrically generate the intermediate electrical circuit voltage.

In this way, dimensioning of the electrical energy consumer supplied by the intermediate electric circuit voltage, e.g. in the form of auxiliary operation converters and train energy supply devices can be carried out in an advantageously favorable way. The specified elements generally ideally require an intermediate electric circuit voltage which is as constant as possible and is provided in an efficient way with the solution according to the invention.

According to a second aspect, the object is achieved with a method for operating an electrical energy production system, wherein the electrical energy production system is functionally coupled to an intermediate electric circuit, wherein the intermediate electric circuit is functionally coupled to an electric consumer device, comprising the steps:
feeding an intermediate electric circuit voltage set point value, requested by the consumer device, to the pulse rectifier;
operating the pulse rectifier in such a way that a defined portion of the requested intermediate electric circuit voltage is provided independently of a rotational speed of the diesel engine by means of a step-up converter function of the pulse rectifier.

One advantageous development of the electrical energy production system is defined by the fact that a level of the intermediate electric circuit voltage which is higher than the set point value depends exclusively on the rotational speed of the diesel engine. This is supported by the fact that even higher requested levels of the intermediate electric circuit voltage can be provided.

A further advantageous development of the electrical energy production system is characterized in that the pulse rectifier is dimensioned in terms of power for a defined portion of the electrical power which can be generated by means of the diesel engine and the generator device. In this way the pulse rectifier can advantageously be implemented in a more cost-effective and technically less complex fashion, as a result of which dimensioning of the electrical consumer device which is connected downstream can also be implemented more cost-effectively and in a less technically complex fashion.

A further advantageous development of the electrical energy production system is defined by the fact that the pulse rectifier is dimensioned to a range from approximately less than or equal to 50% of the electrical power which can be generated by means of the diesel engine and the generator device. In this way a good compromise is implemented between electrical performance and cost efficiency of the pulse rectifier.

A further advantageous development of the electrical energy production system provides that electronic switching elements of the pulse rectifier can be functionally connected to diodes of the passive rectifier in one unit. In this way, the diodes of the pulse rectifier can at the same time also perform the functionality of the passive diode rectifier.

A further advantageous development of the electrical energy production system is characterized in that the pulse rectifier can be actuated in such a way that the diesel engine is driven by means of the generator device. In this way, the generator device can advantageously function as an electrical starter for the diesel engine by means of a reversal of the direction of the energy.

A further advantageous development of the electrical system is defined by the fact that a defined electrical input voltage requested by the electric consumer device, is used as a manipulated variable for the pulse rectifier. As a result, a level of the intermediate electric circuit voltage is provided which supplies all the individual elements of the electrical consumer device in an electrically sufficient fashion.

The properties, features and advantages of the invention which are described above as well as the way in which they are achieved become clearer and more clearly comprehensible in conjunction with the following description of the exemplary embodiments which are explained in more detail with reference to figures.

In the drawings:

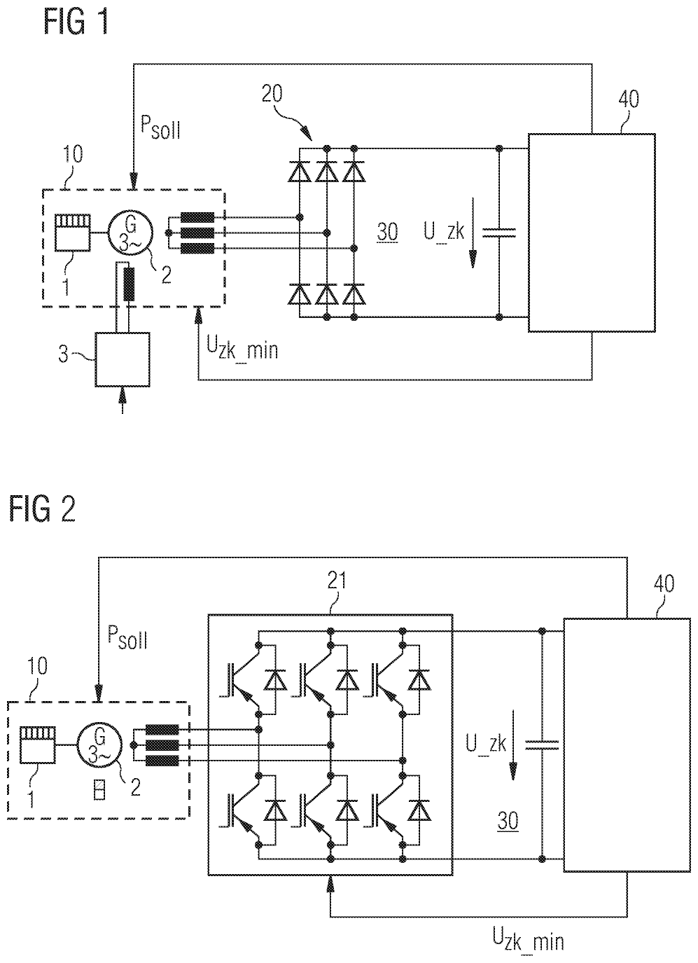

FIG. 1 principally shows a block circuit diagram of a conventional electrical energy production system;

FIG. 2 shows a basic block circuit diagram of a further conventional electrical energy production system;

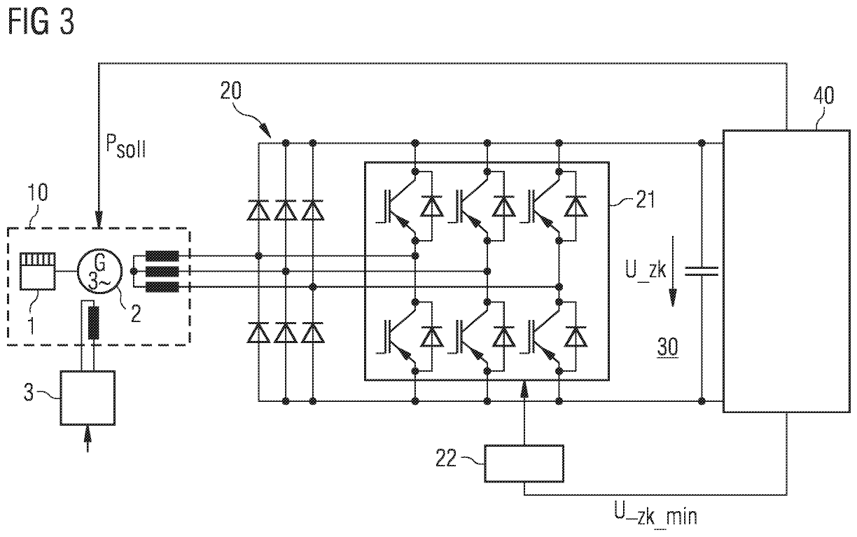

FIG. 3 shows a basic block circuit diagram of an embodiment of a proposed electrical energy production system;

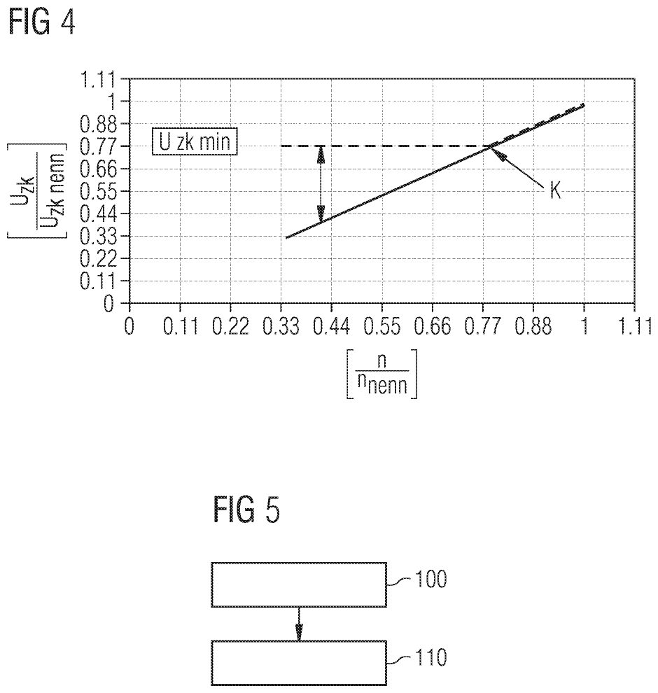

FIG. 4 shows a signal diagram of a profile of a standardized intermediate electrical circuit voltage plotted against the standardized rotational speed of the diesel engine; and

FIG. 5 shows a basic sequence of an embodiment of the method according to the invention for operating an electrical energy production system.

If the pure traction function of a diesel-electric vehicle is considered, the function is conventionally performed by virtue of the fact that the diesel engine is directly coupled to a direct current generator or to a three-phase current generator and diode rectifier connected downstream.

FIG. 1 shows a block circuit diagram of a voltage generating device 10 with a diesel engine 1 which is functionally connected to a separately excited generator device (three-phase generator) 2. A rotational speed n_{d} of the separately excited generator device 10 is provided here by the diesel engine 1, wherein in order to provide a defined rotational speed n_{d}, for example, a diesel injection quantity of the diesel engine 1 is correspondingly metered.

The generator device 2 is separately excited by an exciter device 3 and as a result implements a separately excited synchronous machine. In this context, e.g. an electric voltage of an on-board power system battery is fed to the generator device 2 via a regulator, wherein an electrical voltage is embodied as a function of the generated three-phase voltage. The three-phase electrical output voltage of the generator device 2 is fed to a rectifier device 20 in the form of a passive diode rectifier. A rectified electrical output voltage u_{ZK} (intermediate circuit voltage) is available at the output of the rectifier device 20, in an intermediate circuit 30 with an intermediate circuit capacitor, to which output voltage u_{ZK} an electrical load, in the form of at least one power converter of an electrical consumer device 40 can be connected.

Power converters of the electrical consumer device 40 can be embodied as a traction power converter, auxiliary operation power converter, train power supply etc., wherein electric auxiliary operations of the diesel-electric vehicle, such as, for example, air conditioning system, heating system, actuation of brakes etc., can be supplied with electricity by means of the auxiliary operating power converters.

A signal of a setpoint point P_{Soll} and a signal of a requested minimum intermediate electric supply voltage u_{ZK_min} is fed to the voltage production device 10 by the electrical consumer device 40. The excitation for the generator device 2 is changed in accordance with the requirement of the electrical consumer device 40 and/or the associated loading of the intermediate circuit 30. The rotational speed of the diesel engine 1 is set approximately for the production of the power of the intermediate circuit 30, wherein fine adjustment by means of the exciter device 3 is carried out.

Therefore, in this way a hybrid vehicle is implemented, the electrical energy of which is generated by means of the diesel engine 1 and the generator device 2.

From the intermediate electric circuit 30 onward the technology of such a hybrid vehicle is largely identical with a pure electric locomotive. An alternating electrical voltage for the requirements of the operation of the hybrid vehicle, e.g. for the traction motors, the auxiliary operations, etc., is generated from the intermediate electric circuit voltage u_{ZK} by means of at least one inverter.

The rectifier 20 provides in this case the entire electrical power of the intermediate circuit 30 for the at least one power converter.

The rotational speed of the diesel engine 1 follows here e.g. what is referred to as the propeller curve:

$$nDiesel = \sqrt[3]{Paktuell \text{/} {PN}_{Diesel}} \times {n}_{Nenn \_ Diesel} \qquad ( 1 )$$

with the parameters:

n_{Diesel} . . . rotational speed of the diesel engine

Pₐₖₜᵤₑₗₗ . . . the power provided by the diesel engine

P_{N_Diesel} . . . the rated power of the diesel engine

n_{Nenn_Diesel} . . . the rated rotational speed of the diesel engine

On the basis of the formula (1) a high rotational speed of the diesel engine 1 is generally necessary to achieve a high power level, wherein the power Pₐₖₜᵤₑₗₗ which is provided is e.g. proportional to the third power of the rotational speed n_{Diesel} of the diesel engine 1. The generator devices 2 which are driven by diesel engines usually have separate electrical excitation. This results in an intermediate electric circuit voltage u_{ZK} which is proportional to the rotational speed of the diesel engine 1. This characteristic fits well the requirements of the traction motors of the diesel-electric vehicle. The exciter device 3 performs fine adjustment and load balancing of the three-phase current generator 2 here.

The power also increases with the rotational speed of the diesel engine 1, but a case can occur in which even though a high intermediate electric circuit voltage is requested, a high electrical power is not requested, e.g. in the stationary state of the diesel-electric vehicle. However, owing to the formula (1) this always requires a high rotational speed of the diesel engine 1 with the corresponding disadvantageous effects in respect of primary energy consumption and emissions of the diesel engine 1.

If the requirements of the auxiliary operations and of the train energy supply (e.g. electrical voltage which is as constant as possible in the entire rotational speed range of the diesel engine 1) are considered, the following disadvantages are then involved:

The inverters and transformers have to be configured for high electrical currents for operation with a small intermediate circuit electrical voltage u_{ZK} and for the high intermediate electric circuit voltage u_{ZK} for operation with a high intermediate electric circuit voltage u_{ZK}.

Alternatively, the internal auxiliary operations of the diesel-electric vehicle can be provided with a separate, small inverter and the train energy supply with its relatively high power is configured only for a restricted electrical voltage range. However, this has the disadvantageous result that when a train energy supply is switched on the diesel engine 1 always has to operate with increased or high rotational speed.

Relatively recent developments deal with the abovementioned problem of coupling a generator to an intermediate circuit 30 by using a pulse rectifier, also referred to as AFE (active front end).

FIG. 2 shows such a conventional arrangement, wherein in this case the generator device 2 is embodied as an asynchronous machine or as a machine which is permanently excited by means of a permanent magnet. With such machines it is necessary, in order to implement the desired output voltage, to set absent magnetization by means of a reactive current on the power side, wherein the electric active current is provided by means of the pulse rectifier 21. As a result, the generator device 2 can be magnetized or demagnetized.

As a result, the machine types of the asynchronous generator and permanently excited synchronous generator which are of simple design in terms of the principle involved can also be used as a three-phase generator. In this context, increased complexity, failure probability and investment costs in the power converter disadvantageously occur.

It is proposed to solve the problem by connecting a pulse rectifier 21 with a defined lower power P1 in parallel with a conventional solution with a generator device 2 and a passive rectifier 20.

One embodiment of such an energy production system is illustrated in principle in FIG. 3. It is apparent that the request signal of the minimum intermediate electric voltage circuit u_{ZK_min} of the electric consumer device 40 is in this case fed to the control device 22, by means of which the pulse rectifier 21 is actuated to generate a defined portion of the intermediate electric circuit voltage u_{ZK}. This portion is advantageously independent of the rotational speed of the diesel engine 1. In this way, decoupling of the functionality of rotational speed and intermediate electric circuit voltage is advantageously achieved, as a result of which efficient and economic operation of the diesel engine 1 is assisted.

Alternatively (not illustrated in the figures), a pulse rectifier 21 can be used with diodes which are configured in a powerful fashion and more weakly dimensioned electronic switching elements (e.g. transistors). In this way, the functionality of the passive rectifier 20 and of the pulse rectifier 21 can be implemented in a single module, wherein in this case the diodes of the pulse rectifier 21 also perform the function of the passive rectifier 20.

In the range of low power, i.e. P<P1 and a low rotational speed of the diesel engine, the pulse rectifier 21 steps up the intermediate electric circuit voltage u_{ZK} to the minimum intermediate circuit voltage u_{ZK_min}. P represents here an electrical power which can be generated by means of the diesel engine 1 and the generator device 2. If the requested power P1 exceeds, the power flux in the case of no longer clocking pulse rectifier 21, as in the case of the conventional solution according to FIG. 1, passes exclusively via the passive rectifier 20 in the form of the diode bridges. For this purpose, the power P1 is advantageously selected in such a way that the natural characteristic curve of the rectifier device 2 in the case of P1 just supplies the minimum intermediate electric circuit voltage U_{ZK_min}. In the case of a full load, the high efficiency of the passive rectifier 21 is advantageously used here.

According to the principles of the propeller curve, in this case the pulse rectifier 21 is dimensioned, e.g. in the case of a selected u_{ZK_min} of 0.77, to approximately half the power of the electrical power which is generated with the diesel engine 1 and the generator device 2.

The inventive solution according to FIG. 3 permits virtually all the advantages of a solution with a generator device 2 in the form of an asynchronous machine/permanently excited synchronous machine and exclusively a pulse rectifier 21 which is present to be utilized with reduced expenditure.

As a result, the intermediate electric circuit voltage u_{ZK} can advantageously be increased in the low voltage range, as a result of which economical configuration for the auxiliary operation inverters is advantageously possible.

A setpoint value u_{ZK_min} of the intermediate electric circuit voltage is fed to the pulse rectifier 21, and a setpoint value of the electrical power P_{Soll} is fed to the voltage production device 10. In this way, decoupling of the requirements made of the parameters of the intermediate electric circuit voltage and the power from a rotational speed of the diesel engine 1 can be advantageously achieved. In this context, the electrical power of the intermediate circuit is provided here as before exclusively by means of the rotational speed of the diesel engine 1.

As a result, the diesel engine 1 can be operated at an optimum operating point because it is operated above all with the aim of providing an electrical power, wherein a requirement in respect of the level of the intermediate electric circuit voltage is satisfied by the pulse rectifier 21.

In addition, the pulse rectifier 21 can advantageously be given significantly smaller dimensions in comparison with the conventional solution according to FIG. 2.

In addition, the electric short-circuit currents of the three-phase current generator 2 flow via the robust rectifier bridge of the passive rectifier 20 and do not have a dimensioning effect on the pulse rectifier 21.

The diesel engine 1 can be started from the intermediate circuit 30 by reversing the energy flow via the pulse rectifier 21 and the three-phase current generator 2, so that in this way the three-phase current generator 2 can advantageously function as a starter for the diesel engine 1.

In the event of a failure of the pulse rectifier 21, apart from in the event of a short-circuit when there is no isolator element provided for the rectifier element 21, an emergency operation is possible. For this purpose all that is necessary is to always keep the rotational speed of the diesel engine 1 higher than the rotational speed nₘᵢₙ which is associated with the natural intermediate electric circuit voltage u_{ZK_min} of the three-phase current generator 2.

FIG. 4 shows a basic profile of the standardized intermediate electric circuit voltage u_{ZK}/u_{ZK_nenn} above the standardized rotational speed n/nₙₑₙₙ of the diesel engine 1. A conventional, continuous profile of a linear dependence of the intermediate electric circuit voltage u_{ZK} on the rotational speed of the diesel engine 1 can be seen. The intermediate electric circuit voltage u_{ZK_min} represents here a setpoint value of a consumer of the electrical consumer device 40. When there are a plurality of consumers within the electrical consumer device 40 with different requirements of the electrical intermediate circuit voltage u_{ZK_min} represents the highest requested value of the intermediate electric circuit voltage.

The continuous profile shows a typical profile of an intermediate electric circuit voltage u_{ZK} as a function of the rotational speed which is in the region of approximately 1:3. This corresponds to typical values of an intermediate electric circuit voltage of e.g. 600 V in the case of an idling rotational speed of e.g. 600 rpm and e.g. 1800 V given a maximum rotational speed of e.g. 1800 rpm of the diesel engine 1. This brings about an extremely large input voltage range for the downstream power converter of the electrical consumer device 40, which can make said power converter technically complex and expensive. This means that conventionally the diesel engine 1 has to be operated at a relatively high rotational speed in order to provide the necessary intermediate electrical circuit voltage u_{ZK}. Raising the intermediate electric circuit voltage at low rotational speeds of the diesel engine 1 therefore relieves the power inverter which is supplied with electricity by the intermediate circuit 30, and makes said power converter technically less complex and therefore more cost-effective.

For this purpose, with the solution according to the invention a defined portion of the intermediate electric circuit voltage u_{ZK}, indicated by means of a double arrow, is generated by the step-up converter function of the pulse rectifier 21, because it is provided by the pulse rectifier 21 and only starting from a defined point K owing to the rotational speed of the diesel engine 1. In the case of FIG. 4, this value is, for example, approximately 0.77 of the rated rotational speed of the diesel engine 1.

Of course, this point can be specified in a defined fashion so that the production of the intermediate electric circuit voltage 30 can be divided in a defined fashion between the pulse rectifier 21 and the passive rectifier 20. Starting from the inflection point K, the provision of the intermediate electric circuit voltage u_{ZK} is again performed exclusively by the three-phase current generator 2 which is driven by the diesel engine 1 and whose voltage is rectified by the passive rectifier 20. The double arrow in FIG. 4 therefore represents a portion of the intermediate circuit voltage which is advantageously generated by the pulse rectifier 21 independently of the rotational speed of the diesel engine 1.

Starting from the rotational speed of the diesel engine 1 at the point K, the pulse rectifier 21 in inactive, wherein starting from this point in time the intermediate electric circuit voltage is provided exclusively on the basis of the rotational speed of the diesel engine 1 with the rectifier functionality of the passive diode rectifier 20.

From FIG. 4 it is clear that owing to the dependence of the power on the rotational speed to the third power, the pulse rectifier 21 can be given significantly smaller dimensions than those according to FIG. 2. In the case of FIG. 4, where point K represents approximately 0.77 of the rated rotational speed of the diesel engine 1, the power of the pulse rectifier 21 can be set to 0.77³, i.e. to approximately 45% of the power of the diesel engine 1. In the event of the setpoint value u_{ZK_min} of the intermediate electric circuit voltage being half the rotational speed of the diesel engine, the pulse rectifier 21 only then has to be set to 12% of the power of the diesel engine 1. The double arrow in FIG. 4 therefore indirectly also represents a performance aspect for the dimensioning of the pulse rectifier 21.

From FIG. 4 it therefore becomes clear that a dimensioning of the pulse rectifier 21 can be significantly smaller than the rated power of the diesel engine 1, wherein an actual dimensioning depends on the requirement of the minimum intermediate electric circuit voltage.

FIG. 4 therefore constitutes in particular an acquired degree of freedom for the provision of the intermediate electric circuit voltage.

The method according to the invention can advantageously be controlled with software which is run on the control device 22. With such implementation it is advantageously possible to easily change or adapt the method according to the invention.

FIG. 5 shows a basic flowchart of an embodiment of the method according to the invention for operating an electrical energy production system.

In a step 100, an intermediate electric circuit voltage u_{ZK_min} which is requested by the consumer device 40 is fed to the pulse rectifier 21.

In a step 110 the pulse rectifier 21 is operated in such a way that the required intermediate electric circuit voltage u_{ZK_min} is provided independently of a rotational speed of the diesel engine 1 by means of a step-up function of the pulse rectifier 21.

Although the invention has been illustrated and described in greater detail by means of preferred exemplary embodiments, the invention is not restricted by the disclosed examples and other variations can be derived therefrom by a person skilled in the art without departing from the scope of protection of the invention.

1-9. (canceled)

10. An electrical energy production system, comprising:
a diesel engine;
a three-phase current generator device functionally coupled to said diesel engine;
an intermediate electric circuit functionally coupled to said generator device and to an electric consumer device;
a passive rectifier and a pulse rectifier connected in parallel in said intermediate circuit;
said passive rectifier and said pulse rectifier configured to provide an intermediate electric circuit voltage (u_{ZK}) of said intermediate electric circuit in a defined manner;
said pulse rectifier configured to receive a set point value (u_{ZK_min}) of the intermediate electric circuit voltage (u_{ZK}); and
said pulse rectifier configured to provide a defined portion of the intermediate electric circuit voltage (u_{ZK}) in a defined working range.

11. The electrical energy production system according to claim 10, wherein said diesel engine has a rotational speed on which a level of the intermediate electric circuit voltage (u_{ZK}), being higher than the set point value (u_{ZK_min}), exclusively depends.

12. The electrical energy production system according to claim 10, wherein said pulse rectifier is dimensioned in terms of power for a defined portion of an electrical power to be generated by said diesel engine and said generator device.

13. The electrical energy production system according to claim 12, wherein said pulse rectifier is dimensioned to a range from approximately less than or equal to 50% of the electrical power to be generated by said diesel engine and said generator device.

14. The electrical energy production system according to claim 10, wherein said pulse rectifier has electronic switching elements, said passive rectifier has diodes, and said electronic switching elements of said pulse rectifier are functionally connected to said diodes of said passive rectifier in one unit.

15. The electrical energy production system according to claim 10, wherein said pulse rectifier is configured to be actuated for driving said diesel engine by said generator device.

16. The electrical energy production system according to claim 10, wherein said pulse rectifier receives a manipulated variable being a defined electrical input voltage requested by the electric consumer device.

17. A method for operating an electrical energy production system having a diesel engine, the method comprising the following steps:
functionally coupling the electrical energy production system to an intermediate electric circuit;
functionally coupling the intermediate electric circuit to an electric consumer device;
feeding an intermediate electric circuit voltage set point value (u_{ZK_min}), requested by the consumer device, to a pulse rectifier; and
operating the pulse rectifier to provide a defined portion of the requested intermediate electric circuit voltage (u_{ZK_min}) independently of a rotational speed of the diesel engine by using a step-up converter function of the pulse rectifier.

18. A non-transitory computer-readable medium having a program code stored thereon that when executed on an electronic control device performs the steps of claim 17 for actuating a pulse rectifier.
